(19) United States
(12) Patent Application Publication
(10) Pub. No.: US 2018/0316626 A1
(43) Pub. Date: Nov. 1, 2018

(54) Guided Optimistic Resource Scheduling

(71) Applicant: Futurewei Technologies, Inc., Plano, TX (US)

(72) Inventors: Chen Tian, Union City, CA (US); Sharanyan Srikanthan, Rochester, NY (US); Zongfang Lin, Santa Clara, CA (US)

(21) Appl. No.: 15/960,991

(22) Filed: Apr. 24, 2018

Related U.S. Application Data
(60) Provisional application No. 62/491,959, filed on Apr. 28, 2017.

(51) Int. Cl. H04L 12/927

(52) U.S. Cl. CPC H04L 47/803

(57) ABSTRACT

A system for resource management is disclosed. The system includes a node local resource management layer employed to generate node local guidance information based on coarse grained information and application usage characteristics. A central cluster resource management layer is configured to generate per-framework resource guidance filter information based on the node local guidance information. An application layer, including a plurality of frameworks, is configured to employ the per-framework resource guidance filter information to generate resource guidance filters. The resource guidance filters guide resource requests to the central cluster resource management layer and allow the application layer to receive resources from the node local resource management layer in response to the resource requests to the central cluster resource management layer.

### CROSS-REFERENCE TO RELATED APPLICATIONS

This patent application claims the benefit of U.S. Provisional Patent Application No. 62/491,959, filed Apr. 28, 2017, by Chen Tian, et al., and titled “Guided Optimistic Resource Scheduling,” which is hereby incorporated in its entirety.

### BACKGROUND

Data centers provide resources to software applications. Such resources include memory, processors, network bandwidth, etc. Data centers that are configured to provide cloud computing typically perform elastic provisioning. In elastic provisioning, hardware resources are time shared between many applications of unrelated third parties. Elastic provisioning provides hardware resources to applications on an as needed basis. This approach allows hardware resources to be shifted between applications as resource needs change to mitigate over allocation of resources, thereby increasing overall hardware utilization. Dynamically provisioning resources in this way can become complicated, however, and can create significant computational overhead, especially as data centers become larger and more complex. This may result in slow response time and sub-optimal provisioning as cloud systems scale.

### SUMMARY

In an aspect, the disclosure includes a computer-implemented method for resource management comprising: monitoring current utilization of fine grained resources for corresponding coarse grained resources; determining application usage characteristics of the fine grained resources over time; projecting expected fine grain resource utilization for the application based on the application usage characteristics; generating node local guidance information for at least one framework of a plurality of frameworks requesting the coarse grained resources, the node local guidance generated by comparing the current utilization of fine grained resources to the expected fine grain resource utilization for the application; and communicating the node local guidance information to a resource manager for allocation of the coarse grained resources.

Optionally, in any of the preceding aspects, another implementation of the aspect provides wherein comparing the current utilization of fine grained resources to the expected fine grain resource utilization for the application includes detecting prospective saturation in fine grained resource utilization when the coarse grained resources are allocated to the application.

Optionally, in any of the preceding aspects, another implementation of the aspect provides wherein the fine grained resources include at least one of processor pipeline utilization, processor pipeline occupancy, cache bandwidth, cache hit rate, cache pollution, memory bandwidth, non-uniform memory access latency, and coherence traffic.

Optionally, in any of the preceding aspects, another implementation of the aspect provides wherein fine grained resources include any resource that describe an operational status of any of the coarse grain resources.

Optionally, in any of the preceding aspects, another implementation of the aspect provides wherein the coarse grained resources includes at least one of a number of compute cores, a random-access memory (RAM) space, a storage capacity, and disk quota.

Optionally, in any of the preceding aspects, another implementation of the aspect provides monitoring current utilization of fine grained resources includes monitoring hardware counters configured to count fine grain resource utilization for the coarse grained resources.

Optionally, in any of the preceding aspects, another implementation of the aspect provides wherein the resource manager is a Central Cluster Resource Manager (CCRM), and the node local guidance information is communicated to the CCRM to support generation of per-framework resource guidance filters based on the node local guidance information to guide resource requests.

In another aspect the disclosure includes a computer implemented method of resource management comprising: receiving node local guidance information including expected fine grain resource utilization for a plurality of applications, current fine grain resource utilization, for corresponding coarse grained resources, and coarse grained resource allocations; maintaining a resource availability database based on the coarse grained resource allocations; generating resource guidance filter information for a plurality of frameworks associated with the applications by comparing the current fine grain resource utilization for the coarse grained resources to expected fine grain resource utilization for the applications; and providing the resource guidance filter information and information from the resource availability database to the frameworks to support generating resource guidance filters to mask coarse grain resources when current fine grain resource utilization for the coarse grained resources plus expected fine grain resource utilization for an application exceeds a threshold.

Optionally, in any of the preceding aspects, another implementation of the aspect provides wherein the fine grained resource utilization includes at least one of a processor pipeline utilization, a cache bandwidth, a cache hit rate, a memory bandwidth, and a non-uniform memory access latency.

Optionally, in any of the preceding aspects, another implementation of the aspect provides wherein the coarse grained resources include at least one of a number of compute cores, a random-access memory (RAM) space, a storage capacity, and disk quota.

Optionally, in any of the preceding aspects, another implementation of the aspect provides wherein the resource guidance filters are applied to information from the resource availability database to provide a per-framework view of available coarse grained resources across a plurality of computing nodes in a network.

Optionally, in any of the preceding aspects, another implementation of the aspect provides wherein the resource requests utilize a lazy update whereby the resource availability database is only updated when a request for resources is received from a framework.

Optionally, in any of the preceding aspects, another implementation of the aspect provides wherein the resource guidance filters are determined by the frameworks and are employed to mask resource availability database information to remove resource nodes from consideration when determining resource requests.

Optionally, in any of the preceding aspects, another implementation of the aspect provides wherein fine grained resources include any resource that describe an operational status of any of the coarse grain resources.

In another aspect, the disclosure includes a system for resource management, comprising: a Node Local Resource Managers (NLRM) configured to generate node local guidance information based on current utilization of fine grained resources for corresponding coarse grained resources and projected fine grain resource utilization for applications based on past application fine grained resource usage characteristics; a Central Cluster Resource Manager (CCRM) configured to generate per-framework resource guidance filter information by comparing the current utilization of fine grained resources for the coarse grained resources to the projected fine grain resource utilization for the applications, and maintain a database of allocable coarse grain resources; and an application layer in communication with the central cluster resource management layer, wherein the application layer includes a plurality of frameworks operating on one or more processors, the frameworks configured to employ the per-framework resource guidance filter information to generate resource guidance filters for application to the allocable coarse grain resources to guide resource requests to the central cluster resource management layer, and receive coarse grained resources from the node local resource management layer in response to the resource requests to the central cluster resource management layer.

Optionally, in any of the preceding aspects, another implementation of the aspect provides wherein the node local guidance information is further based on a utilization of fine grained resources including at least one of a processor pipeline utilization, a cache bandwidth, a cache hit rate, a memory bandwidth, and a non-uniform memory access latency as measured by hardware performance counters managed by the NLRM.

Optionally, in any of the preceding aspects, another implementation of the aspect provides wherein the coarse grained information includes at least one of a number of compute cores, a random-access memory (RAM) space, a storage capacity, and disk quota.

Optionally, in any of the preceding aspects, another implementation of the aspect provides wherein the central cluster resource management layer utilizes a lazy update whereby a resource availability database is only updated when a request for resources is received from the application layer.

Optionally, in any of the preceding aspects, another implementation of the aspect provides wherein comparing the current utilization of fine grained resources for the coarse grained resources to the projected fine grain resource utilization for the applications includes detecting prospective saturation in fine grained resource utilization when the coarse grained resources are allocated to the applications.

Optionally, in any of the preceding aspects, another implementation of the aspect provides wherein the resource guidance filters are employed to mask resource availability database information from the central cluster resource management layer to remove resource nodes from consideration when determining resource requests.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example guided optimistic scheduling system.

FIG. 2 is a schematic diagram of an example Central Cluster Resource Manager (CCRM).

FIG. 3 is a schematic diagram of an example Node Local Resource Manager (NLRM).

FIG. 4A is a method of resource management implemented by the NLRM according to an embodiment.

FIG. 4B is a method of resource management implemented within the CCRM according to an embodiment.

FIG. 5 is a schematic diagram of a resource management device according to an embodiment of the disclosure.

### DETAILED DESCRIPTION

It should be understood at the outset that although an illustrative implementation of one or more embodiments are provided below, the disclosed systems and/or methods may be implemented using various techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a method of optimizing resource utilization while simultaneously maximizing performance for large clusters and data centers using guided optimistic concurrence. Embodiments result in reduced interference of computation jobs and mitigation of computational bottlenecks. Many example resource management systems are only concerned with high level resources, such as processor core allocation, memory allocation, and network bandwidth allocation. However, performance of applications is reliant on low level resources as well, such as pipeline occupancy, cache capacity/occupancy, cache hit rates, cache coherence, non-uniform memory accesses, memory bandwidth, resource interference, etc. By way of example, running input/output intensive threads on one machine and memory computing intensive threads on another machine would be inefficient as such threads can coexist on the same hardware with minimal interference. Further, operating multiple memory computing intensive threads on the same hardware is inefficient as some low level resources, such as cache capacity and/or memory pipeline occupancy, are overused resulting in a bottleneck, while other low level resources are under-utilized. Accordingly, an efficient resource allocation utilizes different levels of resources in one machine while not saturating the use of any single resource.

The present disclosure focuses on managing low level resources (e.g., hardware status indicators). As used herein, a high level resource is any resource that can be directly allocated to a process, such as memory, a processor, or network bandwidth. High level resources are also referred to herein as coarse grained resources. As used herein, a low level resource is any operational indicator that describes the status of a high level resource, such as CPU pipeline usage, cache usage, memory bandwidth. Low level resources are also referred to herein as fine grained resources. Implementations of various embodiments can perform a fine grained resource accounting (FGRA), which is a micro benchmark developed to determine the baseline of hardware capacity and capability at a low level (e.g. stress testing) by analyzing performance counters and operating system statistics. FGRA is performed when the system is in a test mode and creates a benchmark for each low level resource so that a percentage utilization can later be determined at run-time. Bottleneck and interference detection is performed by comparing the runtime monitoring results of application operating on frameworks against the baseline. A framework is a software operating platform that provides predefined software resources to support the deployment of applications. Bottleneck and interference detection is a process that determines the prospective increase in performance that can be obtained by allocating additional high level resources by taking into account the prospective percentage utilization of low level resources. Specifically, a bottleneck in low level resource usage and/or interference between applications due to overutilization of low level resources can result in a situation where additional high level resources do not significantly increase performance. For example, when a shared cache is saturated (over-utilized) allocating an additional processor may not increase performance when the additional processor continuously pauses to wait for cache space during operation. Such bottleneck and interference detection can be employed by node local resource managers (NLRMs) to determine application characteristics. A NLRM is a resource manager that monitors low level and high level resources and allocates high level resources for a single node or a cluster of nodes. As used herein, a node denotes a single computational machine, such as a server, that include hardware for operating applications. Application characteristics are a profile of high level and low level resource usage by an application and/or by a corresponding framework over time. The application characteristics and resource utilization at each resource node are then employed to generate guidance information related to the application operating at the corresponding nodes. Guidance information is information generated by an NLRM and indicates compatibility between applications that may potentially share high level resources. Such compatibility may be determined based on past measured application characteristics of multiple applications and current high and low level resource utilization. The guidance information is forwarded to a Central Cluster Resource Manager (CCRM), which maintains a resource availability database and a list of frameworks operating applications at the resource nodes. The CCRM is a central resource manager that monitors and/or manages high level resource allocation for the network as a whole.

The guidance information is employed to generate resource guidance filter information for each framework. Resource guidance filter information is data, generated based on guidance information, that can be employed to generate a resource guidance filter. The resource guidance filter information may include application usage characteristics of multiple applications, low level resource utilization, and/or high level resource allocation. The CCRM provides the resource guidance filter information and data indicating the available resources to the frameworks upon request. The frameworks can then generate resource guidance filters based on the resource guidance filter information. A resource guidance filter is an application and/or framework specific mask that hides high level resources from view of the corresponding application/framework. Such resources are hidden when allocation of the resources to the corresponding application/framework would not significantly increase performance for the application/framework or would otherwise degrade system wide resource utilization. For example, resources that would experience low level resource saturation if allocated to the application (e.g., based on the applications past low level resource usage) can be hidden from the application/framework. The resource guidance filters can be applied at the frameworks to mask resources to remove inefficient resource combinations from the framework's resource view (e.g. based on the guidance information from the NLRM). As used herein a resource view is a system wide list of high level resources available for allocation to the framework and/or corresponding processes minus resources masked by the resource guidance filters. This allows each framework to have a personalized global view of the system resources. This also allows the NLRMs to micromanage local resource utilization while allowing the CCRM to macro-manage node resources.

The present disclosure provides resource allocation and management at a fine level of granularity which allows for a minimum waste of resources across compute nodes. At the same time, the disclosed resource allocation and management is also designed in a scalable, distributed fashion so as to scale and support large clusters and data centers. The present disclosure uses real-time strategies and monitoring techniques to detect inefficiencies and performance bottlenecks for every resource in the system. The information is used locally within a node by application schedulers for maximizing performance despite the presence of co-running applications. In this context, co-running application indicates any pair of applications that share access to a common high level resource. This interaction with application schedulers happens in the form of resource acquisition guidance information. This guidance information helps each application acquire resources depending on the application's current utilization and takes into account possible interferences from co-running applications.

In an embodiment, guidance information is a suggestion to the application to not acquire certain resources and instead to use certain other resources. For example, consider the following case. Application A is memory intensive. A resource manager can allocate a memory capacity to application A. However, nodes can exhaust memory bandwidth by employing a small subset of all available Central Processing Units (CPUs) at the node. By way of illustration, four to six CPUs (out of a total of twenty CPUs) can exhaust all memory bandwidth for the node. In such a case, allocating more than six CPUs to application A is a waste of CPU resources since no additional performance is gained by further allocation. The resource manager disclosed herein dynamically determines available and used memory bandwidth and guides application A by providing only six CPUs on the resource node even when more CPUs are available. On top of this, the resource manager prevents any other similar application from using the same machine/node, as such similar applications would merely compete for the over allocated memory bandwidth. Resource managers operating without the disclosed mechanisms cannot dynamically understand hardware resources or application characteristics and thus would wastefully allocate resources to application A on the same machine in the hopes of improving performance.

The present disclosure characterizes application performance in terms of low level resources, which allows the applications to acquire high level resources based on corresponding low level resource usage/status. In an embodiment, low level resources include, but are not limited to: CPU pipeline contention, private cache contention due to simultaneous multi-threading, single chip shared cache pollution, single chip shared cache capacity contention, intra-chip inter-process coherence traffic, inter-chip inter-process coherence traffic, local dynamic random access memory (DRAM) bandwidth contention, remote memory bandwidth contention, contention on inter-chip interconnect, network contention, Input/Output (I/O) contention, or any combination thereof. A CPU pipeline is a bus between processors, between a processor and I/O, and/or between a processor and memory. CPU pipeline contention is data traffic congestion that occurs when multiple applications transmit data over a common CPU pipeline. Private cache contention is data traffic congestion that occurs when multiple applications store data in the same private cache memory space. Cache pollution describes situations where an executing application loads data into CPU cache unnecessarily, which causes other useful data to be evicted from the cache into lower levels of the memory hierarchy, degrading performance. Single chip shared cache pollution occurs when cache pollution by a first application causes eviction of useful data cached for a second application. Shared cache capacity contention is data traffic congestion cause by multiple application storing information in a cache that is shared between processor (e.g., a level three cache). Cache coherence is a mechanism of storing uniform data in multiple cache locations. Intra-chip inter-process coherence traffic and inter-chip inter-process coherence traffic describe cache coherent memory usage between multiple applications on the same CPU core and between multiple CPU cores, respectively. Local DRAM bandwidth contention is data congestion caused when multiple applications transmit data across bus(es) connecting a processor to DRAM. Remote memory bandwidth contention is data congestion caused when multiple applications transmit data across a bus to remote memory, such as read only memory (ROM) or other long term storage, where long term indicates storage of data when such data is not actively processed. Contention on inter-chip interconnect is data congestion on bus(es) between CPU cores caused by simultaneous access by multiple application. Network contention is data congestion on bus(es) between a CPU core and a network card caused by simultaneous access by multiple applications. I/O contention is data congestion between a processor and any input or output device caused by simultaneous access by multiple applications.

In an embodiment, these are the low level resources that affect performance. Performance may rely far more on the low level resources than the high level resources. However, most of the low level resources are not directly observable. Therefore, the present disclosure indirectly and approximately infers the low level resources using hardware performance counters in conjunction with FGRA.

In an embodiment, the term potential interference source refers to the characterization of the use of low level resources for every application on a given high level resource at a node. Therefore, the present disclosure determines which resources are overused and which application is overusing which resources on a node by node basis. The disclosed system strives for balance, which allows resources to be fully utilized to the extent possible. Applications become interference sources if and when they are or will compete for the same low level resources (thereby saturating the low level resources use). When a low level resource is not overused despite utilization by multiple applications, then the applications are not considered potential and/or actual interfering applications. However, when a certain low level resource is being overused (which is known due to comparison of current utilization to the FGRA benchmark), applications that use the resource can be labeled as interfering sources and can be assigned/reassigned to separate high level resources (e.g., to different machines).

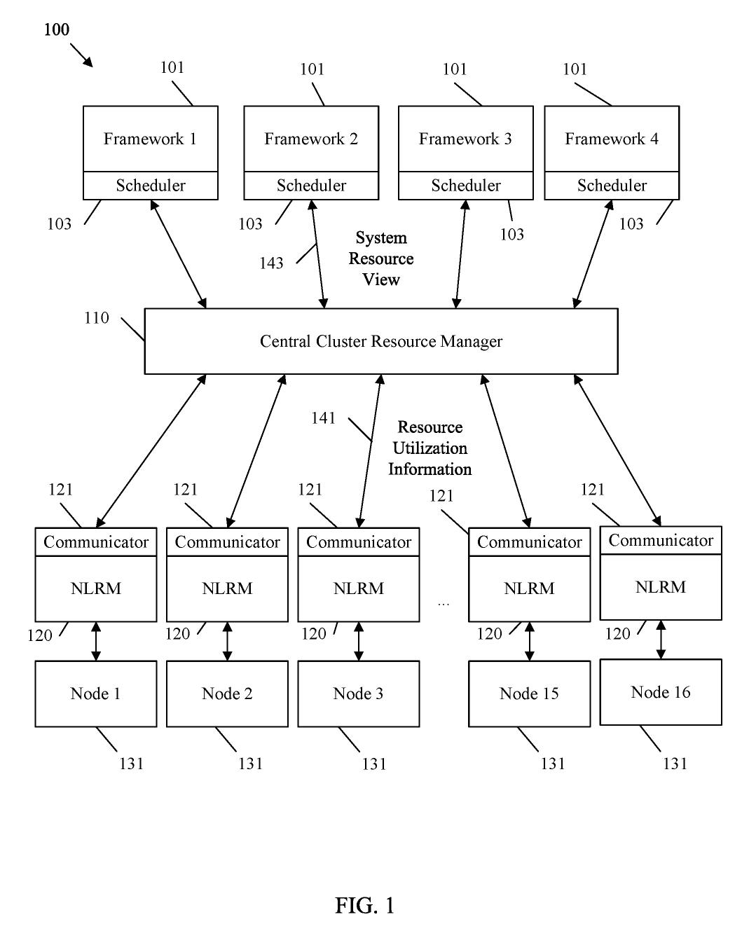

FIG. 1 is a schematic diagram of an example guided optimistic scheduling system 100, which may also be referred to herein as a scheduling system. As shown, the scheduling system 100 includes a plurality of frameworks 101 (e.g., Framework 1, Framework 2, etc.). A framework 101 is an operating environment of development tools, middleware, and/or database services that support deployment of cloud based applications. For example, a framework 101 may operate a platform as a service (PaaS) framework, infrastructure as a service (IaaS) framework, and/or a software as a service (SaaS) framework. The frameworks 101 deploy applications that operate simultaneously on the same physical computing hardware. However, different frameworks 101 may be operated by different tenants. Accordingly, for security reasons, frameworks 101 should not have access to data being processed or stored by other frameworks 101. As discussed below, resource scheduling is employed so that frameworks 101 can share hardware resources (e.g. by taking turns) without accessing each other's data. Each framework 101 utilizes a corresponding scheduler 103. A scheduler 103 is responsible for obtaining hardware resources on behalf of a framework 101 and any corresponding applications that utilize the framework. In some examples, each framework 101 includes a corresponding scheduler 103. However, multiple frameworks 101 may share a scheduler in some examples. In an embodiment, the frameworks 101 and schedulers 103 are disposed within and considered to be part of an Application Layer. While four of the frameworks 101 and schedulers 103 are shown, other number of frameworks 101 and schedulers 103 are possible. In a multi-tenant scenario, several frameworks 101 may share and run tasks on a same node 131. The applications operating on the frameworks 101 may interfere with each other. In an embodiment, hardware performance counters may be utilized to detect such interference.

In an embodiment, the frameworks 101 in the application layer host multiple applications. Each framework 101 employs a corresponding scheduler 103 to communicate with a CCRM 110. Such communication allows the framework to obtain a controlled optimistic resource view of the scheduling system 100, and acquire resources using transactions. The framework 101 is responsible for executing the applications and interacting with the resource management techniques disclosed herein. Based on such interactions, each framework 101 acquires resources and executes corresponding applications on such resources. As opposed to a generic global resource view, frameworks 101 have access to a guided system resource view 143 of the scheduling system 100.

The frameworks 101 communicate with the CCRM 110 and/or the nodes 131. As discussed below, the CCRM 110 provides resource guidance filter information and resource availability information to the frameworks 101 and/or the schedulers 103. Resource availability information is data indicating global high level resources that are available for allocation to any application. Resource guidance filter information is information sufficient to generate a resource guidance filter, which can filter out resources that are incompatible for a particular application. The frameworks 101 and/or corresponding schedulers 103 can compute a resource guidance filter that is specific to the framework 101. Specifically, the resource guidance filter is computed by comparing historical low level resource usage by the application (e.g., based on application usage characteristics) with corresponding percentage utilization of low level resources at each high level resource. When a percentage utilization of any low level resource plus a corresponding historical low level resource usage by the application exceeds a predetermined threshold, the corresponding high level resource is removed from consideration by the resource guidance filter. Hence, the resource guidance filter can be applied to mask resources from the resource availability information. Accordingly, each application receives a guided system resource view 143 of the scheduling system 100 that is specific to the corresponding framework 101. The guided system resource view 143 includes all available high level resources across all nodes 131 in the system minus any high level resources that have been filtered out by the resource guidance filter due to incompatibility of corresponding low level resources with the projected requirements of the application based on past low level resource usage. As such, the guided system resource view 143 is a view of system 100 resources that is tailored to each framework 101 and/or application. Accordingly, the frameworks 101 and schedulers 103 and the CCRM 110 are able to exchange system resource views 142 and/or resource utilization information 141.

The CCRM 110 is responsible for macro-managing hardware resources in the scheduling system 100. Specifically, the CCRM 110 uses information from NLRMs 120 to aggregate and manage resources. The CCRM 110 also generates controlled optimistic system resource views 143 for every application using lazy on-demand updates, accumulates information on resource utilization, performance bottlenecks, and application characteristics from every NLRM 120, provides interference avoidance by using masks, and filters out resources with potential interferences (e.g., a lazy update). Specifically, the CCRM 110 maintains a resource availability database. The CCRM 110 employs lazy on-demand updates to the resource availability database by only updating the database upon receiving a resource query, upon offering resources to a scheduler 103, and/or upon receiving an indication that a scheduler 103 has requested allocation of a particular resource. The lazy update model is less demanding on the CCRM 110 than more active approaches and allows the CCRM 110 to scale to control larger groups of resources. The CCRM 110 receives resource utilization, resource availability, and/or other micro-management information from the NLRMs 120. The CCRM 110 aggregates such fine grained information regarding resource details on each node 131 and exposes resources to each framework 101, for example as an offer in response to a resource request from a scheduler 103. To provide a per-framework 101 system resource view 143 of the scheduling system 100, certain resources may be removed from consideration by employing a resource guidance filter.

The resource guidance filter is generated based on resource utilization information 141 from the NLRMs 120. Such information includes indications of the resource usage at the nodes 131 such as current high level resource allocation (e.g., CPU allocation, memory allocation, etc.) Resource utilization information 141 also includes any corresponding guidance information from the NLRMs 120. Guidance information may include current percentage low level resource utilization for each high level resource, application profiles indicating average historical usage of low level resources for the application requesting resources as well as for other applications sharing the high level resources. The resource guidance filter is generated in part by comparing application profiles to determine whether an application requesting resources is incompatible with an application already operating on a node 131 because sharing of a high level resource would saturate a low level resource. The resource guidance filter may also be generated in part by comparing current low level resource utilization with expected low level resource requirements of an application requesting resources. When allocation of a high level resource to an application would cause the low level resource utilization corresponding to the high level resource to exceed a threshold, then the filter removes the corresponding high level resource from consideration. Hence, the resource guidance filter essentially includes resource micro-management information and is designed to mask resources that would not provide a significant benefit to the framework 101, for example because of bottlenecks, or would degrade the overall system 100 resource utilization. By applying the resource guidance filter to the current high level resource availability, a customized resource view 143 is created for each framework 101/application. The customized resource views 143 include all high level resources available for allocation minus any high level resources that have been filtered out by the resource guidance filter for the application.

The resource guidance filter may be computed by the CCRM 110. However, the CCRM 110 may also provide resource guidance filter information directly to the framework 101 and allow the framework 101 to determine the filter and apply the filter to mask the resources. This approach moves computational overhead from the CCRM 110 to the frameworks 101 and supports additional scalability of the scheduling system 100. The CCRM 110 may also maintain lists or queues of nodes 131 categorized by levels of low level resource utilization. Frameworks 101 are able to choose to acquire resources, e.g. queues for free nodes 131, nodes 131 with a threshold of unused cache bandwidth (e.g., fifty percent), etc.

The CCRM 110 is operably coupled to and in communication with a plurality of nodes 131 (e.g., Node 1, Node 2, etc.). Each node 131 utilizes a corresponding communicator 121 and a NLRM 120 acting as resource monitor/manager. A node 131 includes an integrated group of hardware resources. For example, a node 131 may include a single integrated computing machine, such as a server. Accordingly, a node 131 may include coarse grained resources, such as CPUs, network communication devices and associated bandwidth, computing memory space (e.g. RAM), long term storage space (e.g. disk space), etc. A node 131 may also include fine grained resources that measure the status and utilization of the coarse grained resources. Fine grained resources at a node 131 may be measured by hardware counters and may include, CPU pipeline contention, private cache contention due to simultaneous multi-threading, single chip shared cache pollution, single chip shared cache capacity contention, intra-chip inter-process coherence traffic, inter-chip inter-process coherence traffic, local DRAM bandwidth contention, remote memory bandwidth contention, contention on inter-chip interconnect, network contention, I/O contention, any combination thereof, and/or any other resource referred to herein as a fine grained resource or a low level resource.

An NLRM 120 is disposed within and considered to be part of a node local resource management layer and may act as a resource manager for one or more nodes 131. The NLRM 120 may maintain awareness of the fine grained resource utilization and compare such utilization to a benchmark determined by stress testing (e.g., according to FGRA). This allows the NLRM 120 to determine a percentage capacity utilized for each fine grained resource, which in turn allows the NLRM 120 to micro-manage the nodes 131 resources. The NLRM 120 may also analyze application usage of resources at the associated node(s) 131. Specifically, the NLRM 120 can develop a profile for each application that operates on the node(s) 131 managed by the NLRM 120. The profile includes historical low level resource utilization. For example, the profile may include historical average cache usage, historical average CPU pipeline usage, historical average I/O usage, historical average cache pollution, etc. for the corresponding application. The NLRM 120 can compare the profiles of various applications to determine whether any two applications are incompatible for over utilizing the same low level resource. The NLRM 120 can also compare information from the profile of an application requesting high level resources with the current percentage availability of corresponding low level resources to determine whether the requesting application is projected to cause a saturation/bottleneck in low level resources. Such information can be aggregated along with any other high level resource allocation information from the node and provided to the CCRM as guidance information. The CCRM 110 can in turn aggregate such guidance information from multiple NLRMs 120 and employ such guidance information to generate resource guidance filters as discussed above. The communicators 121 are employed to communicate resource utilization information 141 to the CCRMs 110.

While sixteen of the nodes 131, communicators 121, and NLRMs 120 are shown, the scheduling system 100 may employ any number of such components in practical applications. The CCRM 110 and the nodes 131, communicators 121, and NLRMs 120 are able to exchange resource utilization information 141 as discussed above. In an embodiment, communicators 121 are disposed within and considered to be part of a Communication Layer that bridges micro- and macro-management mechanisms. In an embodiment, the NLRMs 120 are disposed within and considered to be part of a Fine Grained Micro Management Layer. In an embodiment, the Communication Layer and the Fine Grained Micro Management Layer are collectively disposed within and considered to be part of a Node Level Resource Managers Layer.

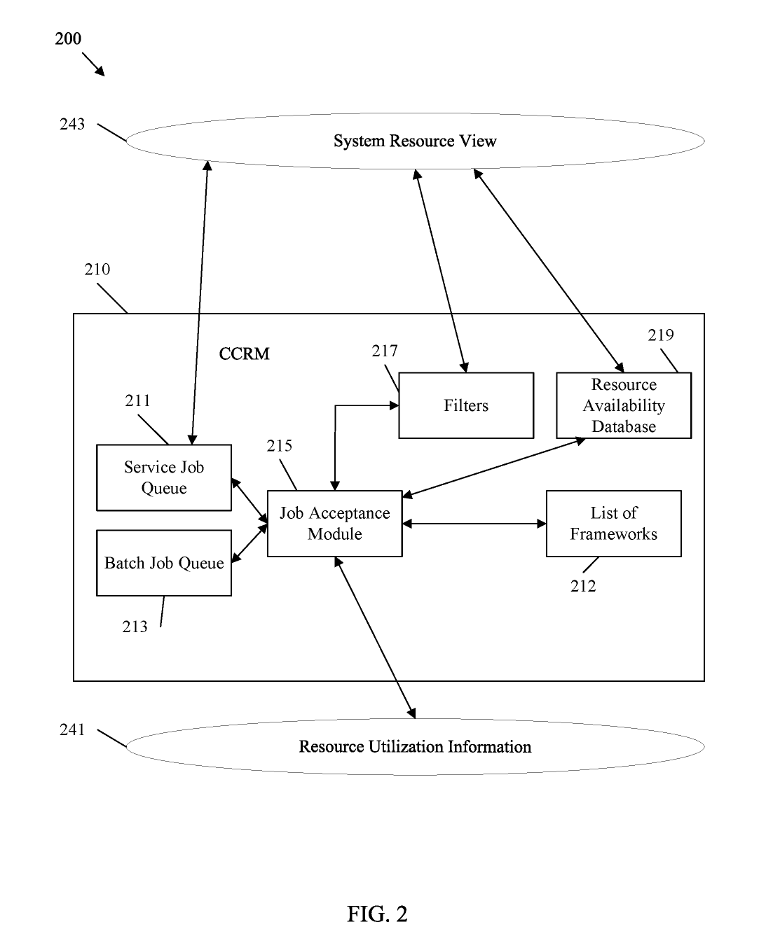

FIG. 2 is a schematic diagram 200 of an example CCRM 210, which may also be referred to as a macro-management module. The CCRM 210 is an example resource manager that may be employed to implement a CCRM 110 in FIG. 1. In an embodiment, the CCRM 210 comprises a service job queue 211, a batch job queue 213, a job acceptance module 215, a list of frameworks 212 that are actively running, resource guidance filter 217 information, and a resource availability database 219. The CCRM 210 is configured to receive resource utilization information 241 from the NLRMs corresponding to each node. The service job queue 211, batch job queue 213, job acceptance module 215, list of frameworks 212, resource guidance filters 217, and resource availability database 219 are in communication with each other as represented by the arrows in FIG. 2. The CCRM 210 is further configured to provide system resource views 243 to frameworks operating applications.

In an embodiment, the CCRM 210 provides either resource guidance filters 217 or resource guidance filter information to each framework, which modifies the system resource view 243 for every framework. For example, a single global resource view (GRV) is maintained internally by the CCRM 210 in the resource availability database 219. The GRV includes all high level resources at all nodes that are available for allocation. The resource availability database 219, and hence the GRV, are updated based on resource utilization information 241 from the nodes using a lazy update as discussed above. As such, the GRV is updated when a framework sends a resource request and/or when high level resources are allocated to a framework/application. The GRV may be provided to the frameworks in response to such resource requests. The CCRM 210 populates the resource availability database 219 with the GRV by aggregating all high level resource allocations from all of the nodes in the system as included in the resource utilization information 241. As the resource availability database 219 maintains a view of all allocated resources, the resource availability database 219 also maintains a view of all remaining available high level resources. The resource utilization information 241 is similar to resource utilization information 141 and may contain node local guidance (e.g. resource micro-management information), fine grained resource utilization at each node, coarse grained resource utilization at each node, application resource usage characteristics, and/or any other information related to resource usage at the nodes.

Framework specific guided resource views (FSGRVs) for individual frameworks are derived from the GRV. As discussed with respect to FIG. 1, the nodes maintain profiles of historical low level resource utilization for each application. The nodes also maintain information for each high level resource indicating the current percentage utilization of corresponding low level resources. Such information is received by the CCRM 210 as guidance information as part of the resource utilization information 241 and aggregated and stored in the resource availability database 219. Upon receiving a resource request from a framework, the CCRM 210 compares a projected low level resource utilization for the requesting application (based on historical low level resource utilization) with current percentage utilization of low level resources for each high level resource. High level resources without sufficient available low level resources to accommodate the projected low level resource utilization for the requesting application are removed from the GRV for the requesting application. This may be determined by adding the current percentage utilization for low level resource to the projected low level resource utilization of the application and comparing the result to a predetermined threshold. By removing certain high level resources from the GRV, a FSGRV is created for the framework requesting the high level resources for the application. Hence, the FSGRV contains a global view of the system that is tailored to the requesting framework/application. As such, the CCRM 210 employs the guidance information to replace the raw resource availability in GRV (e.g., as stored in the resource availability database 219), thus adapting the GRV into a FSGRV that is specific to the application(s) and the compute node(s) the specific application(s) are executing on. The FSGRV can then be forwarded to the frameworks as system resource views 243.

In another embodiment, the per-framework system resource view 243 may be generated by applying resource guidance filters 217, which perform a filtering function in order to generate the FSGRVs. As discussed above, the guidance information indicates all high level resources that are incompatible with an application due to projected saturation of a corresponding low level resource (e.g., due to exceeding a threshold). The resource guidance filters 217 may employ the following equation to remove such incompatible high level resources to create the FSGRV:

fₖ(x)=filterₖ(Σ_{i∈nodes}Resourcesᵢ).

where k represents a framework and i represents a node number. Hence, the FSGRV is the sum of all available system resources on all nodes as filtered for the corresponding framework by removing incompatible high level resources. As noted above, the resource guidance filters 217 may be generated by the CCRM 210 or may be offloaded to the corresponding frameworks for computation and application to resource information from the resource availability database 219.

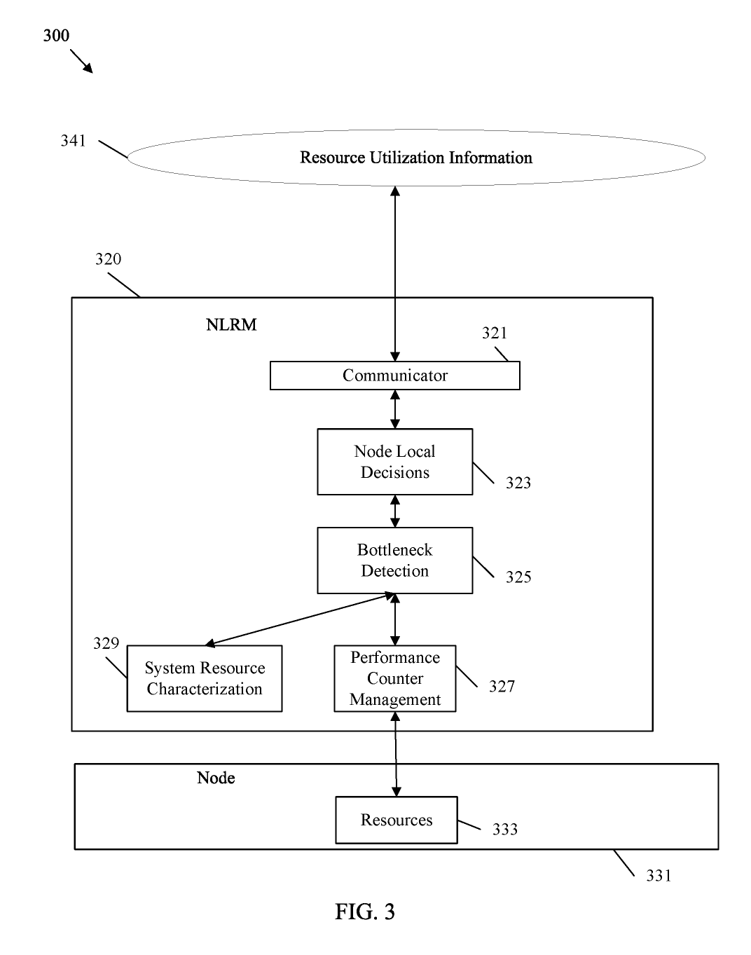

In either case, generation of the FSGRV (e.g., the system resource views 243) by modifying the GRV (e.g., as stored in the resource availability database 219) is performed based on results of the NLRM monitoring the application in each compute node (e.g., Core 1, Core 2, Core 3, etc.) as shown in more detail with respect to FIG. 3 below. One reason behind adapting a FSGRV is to guide the frameworks. Guiding the frameworks ensures that resources are acquired only where performance bottlenecks are at a minimum. FSGRVs intentionally reduce the number of resources that can be acquired by a framework if performance cannot be gained by acquiring additional resources in that compute node. By augmenting restrictions on resource acquisition, FSGRVs also contain information on generic bottlenecks across various compute nodes to aid in application scheduling.

Two job queues are shown in FIG. 2. However, a different number of job queues may be present and/or utilized in practical applications. The job queues maintain applications that are queued up for execution but have not been accepted by the CCRM 210. Job queues are categorized into two types—batch job queues 213 and service job queues 211. Batch applications are maintained in the batch job queues 213, and are largely computationally intensive applications that run to completion. Service applications, which are maintained in the service job queues 213 are applications that satisfy requests and run until the service is requested. Generally, batch applications operate for much shorter periods than service workloads. However, batch applications may be more numerous in number in a datacenter. Service workloads employ quality of service (QoS) guarantees. Therefore, resource requirements for service oriented workloads are much higher than batch workloads. Because maintaining QoS is paramount for service workloads, service workloads are given a higher preference to be accepted by the CCRM 210. Service workloads also enjoy higher priority for resource acquisition. Additionally, service workloads may specify a Minimum Resource Specification (MRS) during job submission. If available resources are less than the MRS of the service job at the head of the queue, the CCRM 210 may stop admitting new batch jobs and wait for resources to be available for the service job.

As a specific example, the CCRM 210 may operate as follows. The CCRM 210 may operate a job acceptance module 215, which may be a process and/or circuit that accepts or rejects resource requests. The job acceptance module 215 may maintain a list of frameworks 212 actively operating on the system. The list of frameworks 212 may also contain application data associated with the frameworks, such as application utilization data received from the NLRM as part of the resource utilization information 241. The job acceptance module 215 may receive and aggregate resource utilization information 241 from multiple NLRMs for multiple nodes. Such information is stored in the resource availability database 219. A framework may determine to schedule a batch or service job. The framework may communicate with the job acceptance module 215 to make such a request, and the batch job or service job may be stored in the batch job queue 213 or the service queue 211, respectively. The job acceptance module 215 may employ the data from the list of frameworks 212 and/or the resource utilization information 241 from the NLRMs to generate the resource guidance filters 217 (or corresponding resource guidance filter information for computation at the requesting framework) as discussed above. The resource guidance filters 217 and the GRV stored in the resource availability database 219 may be communicated to the requesting framework. By applying the resource guidance filters 217 to mask resources from the GRV, a FSGRV is created as a per framework system resource view 243. The FSGRV is treated by the framework as a resource offer. The framework may schedule the resources at the nodes based on the view provided by the FSGRV. Specifically, the FSGRV includes all available high level resources minus the high level resources that would be incompatible with the frameworks applications due to actual or potential low level resource saturation. Hence, the framework can select any high level resources from the FSGRV and requests allocation of such resources via the CCRM 210 and the NLRM. Once the framework has scheduled sufficient resources, the job acceptance module 215 may accept the job and move the job from the corresponding queue into an active state for processing the scheduled resource node(s). In this manner, fine grained resource information from the NLRMs is employed to generate the resource guidance filters 217, and hence micro-management of system resources is employed to remove less efficient resources from consideration. The CCRM 210 can perform macro-management of system resources by controlling the resource availability database 219 and by accepting, rejecting, and/or delaying jobs. Accordingly, the CCRM 210 performs macro-management in a scalable manner, and the NLRM performs micro-management of system resources in corresponding resource nodes. As discussed above, such a scheme provides the advantages of both micro and macro-management without the corresponding drawbacks.

FIG. 3 is a schematic diagram 300 of an example NLRM 320. The NLRM 320 is an example resource monitor that may be employed to implement a NLRM 120 in FIG. 1. The NLRM 320 is coupled to at least one node 331, which may be substantially similar to node 131. The node 331 may be a computing device in a datacenter, such as a server. Hence, the node 331 comprises hardware resources 333. Such resources 333 include high level resources that can be allocated to an application, such as compute cores, RAM space, storage capacity, disk quota, network bandwidth, and/or any other item described herein as a coarse grained or high level resources. The resources 333 also include low level resources that describe the status of the high level resources. Such low level resources may include CPU pipeline contention, private cache contention due to simultaneous multi-threading, single chip shared cache pollution, single chip shared cache capacity contention, intra-chip inter-process coherence traffic, inter-chip inter-process coherence traffic, local DRAM memory bandwidth contention, remote memory bandwidth contention, contention on inter-chip interconnect, network contention, I/O contention, any combination thereof, and/or any other resource referred to herein as a fine grained resource or a low level resource.

The NLRM 320 monitors the utilization of both the coarse grained or high level resources 333 and the fine grained or low level resources 333, detects any saturation in utilization or performance bottlenecks, deduces application characteristics, and generates node local guidance for every framework based on these factors. The node local guidance is then forwarded to a CCRM, such as CCRM 110 and/or 210 as part of the resource utilization information 341, which is substantially similar to resource utilization information 141 and/or 241. For example, the NLRM 320 is configured to perform interference detection between resources 333 when such resources 333 are shared between applications and provide such information to the CCRM as node local guidance. As such, the node local guidance can indicate to the CCRM that low level resources utilization by particular applications are interfering with each other and that such applications should be reallocated.

In an embodiment, the NLRM 320 provides performance counter setup, multiplexing, reading, and accounting for every compute core in the resources 333. The NLRM 320 also handles consolidation of information, assessing resource utilization, performance bottlenecks, and application characteristics. Specifically, the NLRM 320 monitors low level resource usage for each resource 333 by employing corresponding hardware counters. The NLRM 320 generates node local resource acquisition guidance information for every application based on past low level resource usage by the applications and current low level resource usage as determined by the counters. In some examples, the NLRM 320 may also filter out high level resource availability for the CCRM. For example, a high level resource that is otherwise allocable can be listed as allocated when corresponding low level resource utilization is above a threshold. The NLRM 320 uses a communicator 321 in the communication layer to interact with the CCRM.

For example, the NLRM 320 may employ FGRA, which is a micro benchmark developed to determine a baseline of hardware resource 333 capacity and capability for low level resources by stress testing and analyzing performance counters and operating system statistics. Accordingly, the NLRM 320 is aware of the maximum operational utilization of each of the low level grained and high level resources 333. The appropriate baselines are stored in the NLRM 320 memory for use at runtime. The NLRM 320 employs a performance counter management 327 module to manage, read, and report data from hardware counters that measure the low level resources 333 during use by applications. The NLRM 320 also employs a bottleneck detection 325 module that receives the results from performance counter management 327. The bottleneck detection 325 module is configured to compare the data from performance counter management 327 to the FGRA baseline to determine a percentage utilization of the fine grained resources. The bottleneck detection 325 module can employ the results of the comparison to detect fine grained resource bottlenecks and resource 333 saturation. Accordingly, the bottleneck detection 325 module is capable of determining when adding additional high level resources 333 to an application would not provide a benefit due to conflicts with the low level resources.

The NLRM 320 may also include a system resource characterization 329 module. System resource characterization 329 may receive data from bottleneck detection 325 and/or performance counter management 327. This allows the system resource characterization 329 module to characterize the typical resource 333 usage of various applications. For example, the system resource characterization 329 module may employ artificial intelligence principles to observe an application and create a profile describing the application's typical low level resource 333 usage. As a particular example, the system resource characterization 329 module may determine that an application is heavy I/O user, a heavy cache user, etc. Accordingly, the system resource characterization 329 module can determine typical low level resource 333 usage patterns. Such patterns may be employed to determine whether particular applications are compatible to share resources 333 on the same machine. Such patterns may also be employed to create a projected low level resource 333 utilization for an application, which can be compared to a current low level resource utilization associated with the high level resources as measured by the system counters at the resources. The results of such a comparison can be employed to determine high level resources 333 that are incompatible with particular applications due to current low level resource usage.

The NLRM 320 further includes a node local decisions 323 module. Node local decisions 323 receives data from bottleneck detection 325, system resource characterization 329, and/or performance counter management 327. The node local decisions 323 module employs such information to micromanage the resources 333 of the node(s) 331. For example, node local decisions 323 may create node local guidance information for use by the CCRM. The node local guidance information may indicate that particular fine grained resources are saturated or available for greater utilization. The node local guidance information may also include application characteristics, and hence may indicate the compatibility of particular applications (or lack thereof). Accordingly, the node local guidance information can be employed by the CCRM to create filters to remove particular resources 333 from the system resource view of particular frameworks/applications. The NLRM 320 also manages coarse grained resource 333 allocations, and hence sends node local guidance information, fine/coarse grained resource utilization, and/or application characteristics to the CCRM via the communicator 321 as resource utilization information 341. The communicator 321 may be any communication device capable of forwarding information between the CCRM and the NLRM 320 (e.g., a network card).

Accordingly, the NLRM 320 performs complex resource accounting by employing hardware counters to measure low level resources by applications over time. This allows the NLRM to project low level resource utilization for each application, determine prospective and/or current performance bottlenecks, and determine application resource usage characteristics. Resource utilization reflects the actual usage of each type of resource. Resource utilization includes high level resources used during acquisition (e.g., CPU, memory, disk, network, etc.) and lower level resources that are key for performance (e.g., pipeline occupancy, cache capacity, cache hit rates, non-uniform memory accesses, etc.). While applications only acquire high level resources, the low level resources dictate the actual performance. A NLRM 320 monitors the low level resources by using hardware performance counters. Hardware performance counters are available on processors and have low overheads. However, hardware performance counters are very limited in number and may monitor only a subset of characteristics.

NLRMs 320 use a custom designed time multiplexing of hardware performance counters by employing the performance counter management 327 module. Additional systems are then employed to derive statistics such as cache miss rates, last level cache occupancy, coherence traffic, etc. These derived statistics constitute the low level resources, show the actual resource utilization in the system on a per application basis, and show a current percentage of low level resource utilization.

As noted above, the NLRM 320 also characterizes hardware offline using specialized stress benchmarks. By employing these offline measurements, heterogeneous hardware may be assessed for low level resource 333 capability. Offline capability and online measurements are used to detect performance bottlenecks at bottleneck detection 325. As the NLRM 320 is aware of resource utilization and performance bottlenecks, the NLRM 320 can extract application characteristics information for every application executing on the local node 331. The application characteristics include a tally of the resources that are most used by the application (both high level resources and low level resources), inefficiencies of the application (e.g., low cache hit rate, high remote memory accesses, high coherence traffic, etc.), performance bottlenecks (e.g., saturated memory bandwidth, high cache occupancy, etc.), and source of interference (e.g., other applications that compete for the same type of resources that the application requires).

Application characteristics are used for generating guidance for resource acquisition. Controlling the number of cores available for acquisition is the strongest way to control applications. More flexible control measures would be to control the size of RAM available, disk space available, etc. Additional guidance efforts can help distribute the load on multiple sockets within a machine depending on resource utilization on each socket by restricting core availability on every socket. It is also possible to force a heavily interfering batch application to reduce execution on a given node 331 to make additional room for a service oriented workload, if desired. Application characteristics, along with resource acquisition guidance, are sent to the CCRM by NLRM 320 for every application. This information is then consolidated in the CCRM and combined with GRVs to generate a FSGRV that ultimately decides resource availability for every framework.

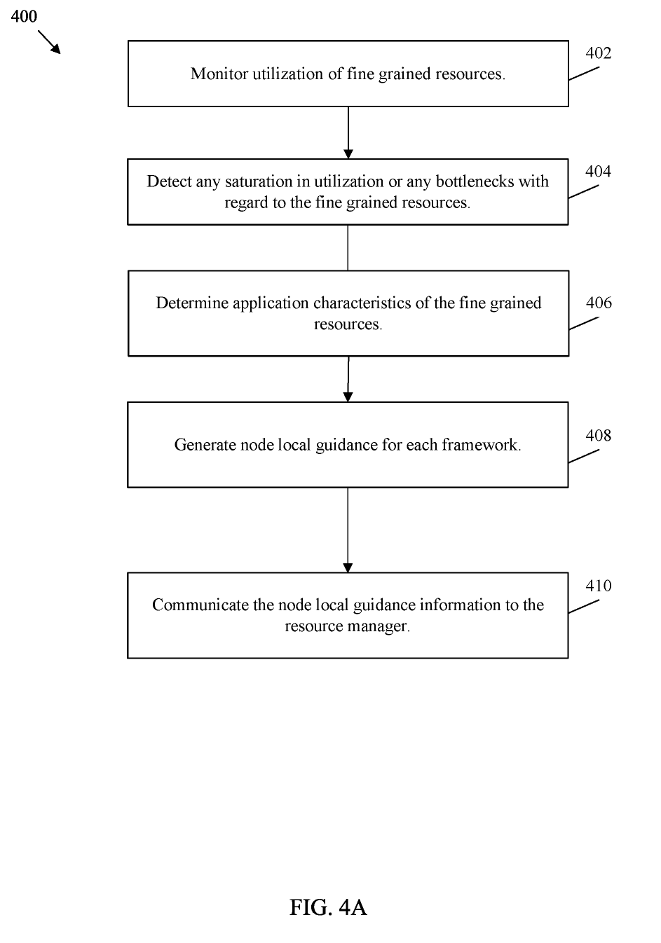

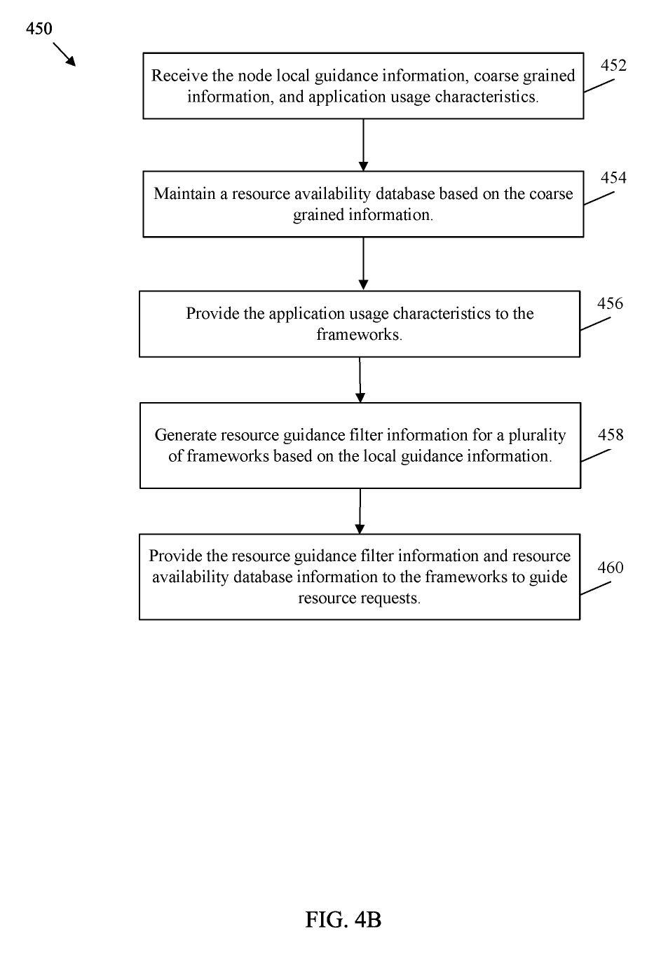

FIG. 4A is a method 400 of resource management implemented by the NLRM, such as NLRM 120 and/or 320, according to an embodiment. For example, method 400 may be employed by a NLRM to generate resource utilization information 141, 241, and/or 341 for a CCRM 110 and/or 210 based on information regarding resources 333 at a node 131 and/or 331.

At block 402, a resource monitor/manager at the NLRM monitors utilization of both fine grained resources and coarse grained resources at a node. As mentioned above, coarse grained resources include resources that can be directly allocated to an application, such as a number of compute cores, a RAM space, a storage capacity, disk quota, and combination thereof and/or any other resource referred to herein as a coarse grained resource or a high level resource. Meanwhile a fine grained resource includes status information for the coarse grained resources and/or any computing resource that cannot be directly allocated to a process, such as processor pipeline utilization, processor pipeline occupancy, cache bandwidth, cache hit rate, cache pollution, memory bandwidth, non-uniform memory access latency, and coherence traffic, any combination thereof, and/or any other resource referred to herein as a fine grained resource or a low level resource.

At block 404, the resource monitor/manager at the NLRM detects any saturation in utilization of the fine grained resources and/or any bottlenecks with regard to the fine grained resources. Saturation includes cases where utilization of a fine grained resource exceeds a threshold. Such a threshold may vary from resource to resource and may be set by an administrator and/or be predefined. For example, saturation may occur when usage of shared cache (e.g., a level three cache) exceeds a threshold expressed as a percentage of maximum capacity, such as sixty percent. Saturation indicates that further allocation of the coarse grained resources (e.g., another CPU core) is unlikely to add additional processing capacity because there is insufficient availability of the supporting fine grained resource to make adequate use of the coarse grained resource. Bottlenecks include cases where existing allocations have overused a fine grained resource, and that processing is slowed because currently allocated applications are slowing down due to wait times associated with sharing the overused fine grain resources. A bottleneck may indicate that at least one associated application should be moved to another node to mitigate further system slowdown.

At block 406, the resource monitor/manager at the NLRM determines application usage characteristics of the coarse grained resources and the fine grained resources. Determining application usage characteristics includes developing a profile of fine grained resources usage for corresponding applications over time. Such application resource usage may include average fine grained resource usage, fine grained resource usage at particular times, and/or any other fine grained resource usage patterns. The application usage characteristics may be determined according to hardware resource counters. In some examples, fine grained resource saturation and/or bottlenecks may be detected during determination of application usage characteristics. Hence, blocks 404 and 406 may be combined in some examples.

At block 408, node local guidance is generated for one or more of the frameworks, such as frameworks 101, operating on the system. For example, the resource monitor/manager at the NLRM may generate node local guidance for each framework that is employing an allocated fine grain and/or coarse grain resource on the node (e.g., for use by a corresponding application) managed by the NLRM. The node local guidance is generated based on the utilization of the fine grained resources, as determined in block 402, saturation and/or bottlenecks, as determined in block 404, the application usage characteristics, as determined in block 406, and/or any combination thereof. For example, the node local guidance may include an indication that particular applications are incompatible due to competition for a common fine grained resource. As another example, the node local guidance may include a directive to remove a particular application from the node due to fine grained resource usage of the corresponding application. As another example, the node local guidance information may include application usage characteristics measured at the node, fine grained resource utilization information, coarse grained resource utilization information, and/or any other resource utilization information.

At block 410, a communicator at the NLRM communicates the node local guidance information to a resource manager for the entire system. As noted above, the NLRM micro-manages resources at the node while a resource manager, such as a CCRM, macro-manages resources across all of the nodes in the system. In some examples, the CCRM may make changes to resource allocations at the node based on the node local guidance information. For example, the CCRM may force an application to move to another node. In other examples, the CCRM employs the node local guidance information (e.g., application usage characteristics, fine grained resource utilization information, coarse grained resource utilization information, resource utilization information, etc.) to generate per-framework resource guidance filters. Such filters are hence generated based on the node local guidance information to guide resource requests by the frameworks. As noted above, in some cases, the CCRM offloads computation of the resource guidance filters to the frameworks, and hence generate resource guidance filter information based on the node local guidance information. As such, the node local guidance information generated and communicated by method 400 is employed to inform system wide resource allocation when considering applications that impact the node managed by the NLRM.

FIG. 4B is a method 450 of resource management implemented within a CCRM, such as CCRM 110 and/or 210, according to an embodiment. For example, method 450 may be employed by a CCRM to receive resource utilization information 141, 241, and/or 341 from an NLRM, such as NLRM 120 and/or 320, and determine resource allocations and/or provide a per-framework system resource view, such as system resource view 143 and/or 243. As such, method 450 may be employed in conjunction with method 400 to operate the systems described herein.

At block 452, the CCRM receives resource utilization information, such as resource utilization information 141, 241, and/or 341 from an NLRM. The resource utilization information includes node local guidance information, fine grained resource utilization information, coarse grained resource utilization information, application usage characteristics, or combinations thereof. As noted above, the node local guidance information is based on a utilization of fine grained resources including at least one of a processor pipeline utilization, a cache bandwidth, a cache hit rate, a memory bandwidth, a non-uniform memory access latency, and/or any other fine grained resource/low level resource disclosed herein. Further, the coarse grained information includes at least one of a number of compute cores, a RAM space, a storage capacity, a disk quota, and/or other coarse grained resource/high level resource disclosed herein.

At block 454, the CCRM maintains a resource availability database based on the coarse grained information. The CCRM aggregates the resource utilization information from the NLRMs to maintain the resource availability database. The resource availability database maintains a system wide view of the resource allocation at the various nodes. In some examples, information from the resource availability database is offered, upon request, to frameworks operating applications to support allocation of resources.

At block 456, the CCRM provides the application usage characteristics to the frameworks. Block 456 is optional. Block 456 is employed to allow the frameworks to determine their own fine and coarse grained resource usage. This may allow the frameworks to operate optimization processes and/or perform other resource management tasks related to the applications.

At block 458, the CCRM generates resource guidance filter information for the frameworks based on the local guidance information. As noted above, the local guidance information includes data regarding fine grained resource utilization at the nodes. In some cases, the CCRM may employ the local guidance information to move applications when fine grained resources are saturated and/or when fine grained resource utilization has caused bottlenecks at the nodes. In other examples, the CCRM may employ the local guidance information, application usage characteristics, and/or fine/coarse grained resource utilization to determine which applications should not operate on the same nodes. In some examples, the CCRM may employ such information to generate resource guidance filters for each framework. The resource guidance filters can then be employed to mask incompatible resources from the corresponding applications/frameworks. In other examples, the CCRM may instead compile resource guidance filter information that the corresponding frameworks can employ to generate the resource guidance filters. This approach allows the computational overhead associated with generating the resource guidance filters to be offloaded from the CCRM to the frameworks, which increases the operational speed of the CCRM and supports scalability of the system.

At block 460, the CCRM provides the resource guidance filter/resource guidance filter information as well as information from the resource availability database to the frameworks. This approach supports generating resource guidance filters at the framework. The resource guidance filters can then be applied to the resource availability database information to remove resource nodes from consideration on a per framework basis when determining resource requests. Accordingly, the frameworks can generate resource requests for resources indicated in the resource availability database information. The resource requests from the frameworks are guided by per-framework resource guidance filters. As such, the resource guidance filters and the resource availability database information provide a per-framework system resource view of node local resources based on both fine grained resource utilization and coarse grained resource utilization. As noted above, resource requests from the frameworks may utilize a lazy update. In a lazy update scenario, the resource availability database is only updated when a request for resources is received from a framework at the CCRM. This approach reduces the number of updates and hence reduces computational overhead at the CCRM, which results in increased scalability of the system.

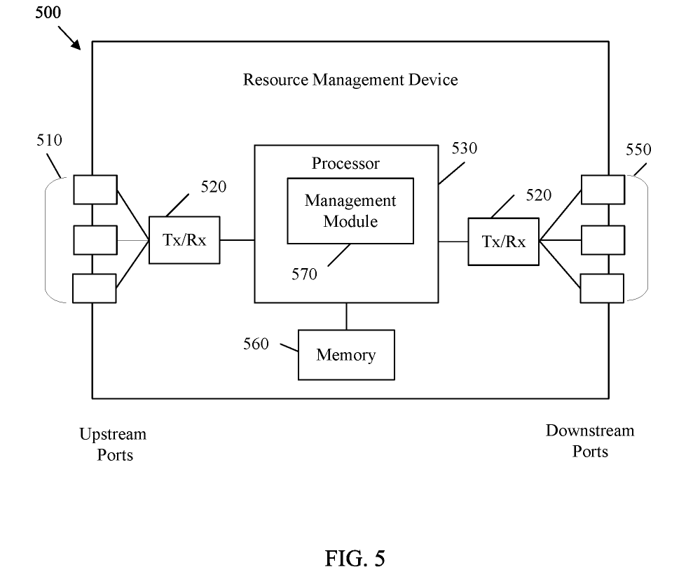

FIG. 5 is a schematic diagram of a resource management device 500 according to an embodiment of the disclosure. The resource management device 500 is suitable for implementing the disclosed embodiments as described herein. For example, the resource management device 500 can be employed to implement a node 131, a NLRM 120 and/or 320, a CCRM 110 and/or 210, and/or any other component in a data center. Further, a resource management device 500 can be employed to implement method 400 and/or 450.

The resource management device 500 comprises upstream ports 510, downstream ports 550 and transceiver units (Tx/Rx) 520 for receiving and transmitting data; a CPU, logic unit, or processor 530 to process the data; and a memory 560 for storing the data. The resource management device 500 may also comprise optical-to-electrical (OE) components and electrical-to-optical (EO) components coupled to the upstream ports 510, the Tx/Rx units 520, and the downstream ports 550 for egress or ingress of optical or electrical signals.

The processor 530 is implemented by hardware and software. The processor 530 may be implemented as one or more CPU chips, cores (e.g., as a multi-core processor), field-programmable gate arrays (FPGAs), application specific integrated circuits (ASICs), and digital signal processors (DSPs). The processor 530 is in communication with the upstream ports 510, Tx/Rx units 520, downstream ports 550, and memory 560. The processor 530 comprises a management module 570. The management module 570 implements the disclosed embodiments described above. For instance, the management module 570 implements, processes, prepares, or provides the various functions of the CCRM and/or the NLRM. The inclusion of the management module 570 therefore provides a substantial improvement to the functionality of the resource management device 500 and effects a transformation of the resource management device 500 to a different state. Alternatively, the management module 570 is implemented as instructions stored in the memory 560 and executed by the processor 530.

The memory 560 comprises one or more disks, tape drives, and solid-state drives and may be used as an over-flow data storage device, to store programs when such programs are selected for execution, and to store instructions and data that are read during program execution. The memory 560 may be volatile and/or non-volatile and may be read-only memory (ROM), RAM, ternary content-addressable memory (TCAM), and/or static random-access memory (SRAM).

From the foregoing, it will be appreciated that the present disclosure provides coarse grained resource management coupled with very fine grained resource accounting, a consolidation step that bridges otherwise incompatible methods, and dynamic resource allocations such that application schedulers are able to minimize the gap between requested and available service level objectives. In addition, the present disclosure provides for fine grained resource accounting implemented using hardware performance counters. The fine grained resource accounting is enhanced and interpreted using hardware aware algorithms that are able to understand resource utilization. The present disclosure also detects performance bottlenecks and deduces application characteristics. The present disclosure provides a guided resource acquisition strategy based on presence of performance bottlenecks and application characteristics are able to optimize scheduling for heterogeneous hardware and minimize interference between applications.

The present disclosure also provides for Macro Management of cluster level resources by adopting an optimistic shared state resource view that is highly scalable and allows a transparent resource acquisition mechanism. Moreover, there is a free for all acquisition of resources within limits set for every application.

The present disclosure bridges micro and macro management with the use of guided optimistic resource scheduling. Micro management generates guidance for every application based on its resource utilization, hardware capacity, bottlenecks present, and other interfering applications. Macro management gathers multiple guidance reports to form a cohesive resource acquisition strategy for every application. In an embodiment, macro-management uses micro-management input to restrict applications from acquiring resources that harm performance. The present disclosure provides for a lazy on-demand update by macro management to ensure scalability. Guided scheduling is implemented by lazy updates performed on-demand of frameworks. This makes system more scalable and there are fewer passive computations.

The present disclosure also restricts applications from acquiring resources when such acquisition would harm performance. In an embodiment, factors affecting performance are not directly related to resources acquired/managed (CPU, RAM space, disk quota, etc.). Additionally, the present disclosure detects application characteristics so that future resource acquisitions may be performed in appropriate machines. For convenience, applications are presented with multiple lists that categorize availability of machines based on low level resource availability.

The present disclosure provides a unique hybrid macro-micro management system that scales well, guarantees performance, and maximizes resource utilization efficiency. The present disclosure provides guidance for resource acquisition generated from node-local low-level resource utilization to maximize performance and efficiency. The present disclosure provides a simple framework-resource manager interface despite very complex low-level resource accounting.

The present disclosure provides dynamic resource allocation that eliminates fragmentation of resources, adapts to fluctuating load, and computational phases. The present disclosure provides lazy on-demand resource guidance to further improve scaling. The present disclosure provides feedback to applications/frameworks to help improve scheduling and code development/optimization.

In order to avoid bottleneck and interference, the present disclosure uses FGRA to generate guidance for every for every application based on its resource utilization, hardware capacity, bottlenecks present, and other interfering applications. CCRM gathers multiple guidance reports to form a cohesive resource acquisition strategy for every application. CCRM also uses fine grained resource accounting input to restrict applications from acquiring resources that harm performance.

To facilitate optimistic decision making, CCRM adopts an optimistic shared state resource view to allow concurrency. Each framework can perform optimistic decision making with transparent resource acquisition. Indeed, CCRM gathers multiple guidance reports of FGRA to form a cohesive resource acquisition strategy for every application. CCRM uses guidance to restrict applications from acquiring resources that harm performance. Optimistic decision making applies filtering to control visibility of resources, to avoid bottleneck, and to avoid interference. The lazy on-demand update reduces passive computation and ensures scalability. CCRM is highly scalable, efficient with high throughput. The present disclosure provides feedback to frameworks to help improve scheduling and code development/optimization.

Also included is a computer-implemented method for resource management comprising: a means for monitoring current utilization of fine grained resources for corresponding coarse grained resources; a means for determining application usage characteristics of the fine grained resources over time; a means for projecting expected fine grain resource utilization for the application based on the application usage characteristics; a means for generating node local guidance information for at least one framework of a plurality of frameworks requesting the coarse grained resources, the node local guidance generated by comparing the current utilization of fine grained resources to the expected fine grain resource utilization for the application; and a means for communicating the node local guidance information to a resource manager for allocation of the coarse grained resources.

Also included is computer implemented method of resource management comprising: a means for receiving node local guidance information including expected fine grain resource utilization for a plurality of applications, current fine grain resource utilization, for corresponding coarse grained resources, and coarse grained resource allocations; a means for maintaining a resource availability database based on the coarse grained resource allocations; a means for generating resource guidance filter information for a plurality of frameworks associated with the applications by comparing the current fine grain resource utilization for the coarse grained resources to expected fine grain resource utilization for the applications; and a means for providing the resource guidance filter information and information from the resource availability database to the frameworks to support generating resource guidance filters to mask coarse grain resources when current fine grain resource utilization for the coarse grained resources plus expected fine grain resource utilization for an application exceeds a threshold.

Also included is a system for resource management, comprising: a means for generating node local guidance information based on current utilization of fine grained resources for corresponding coarse grained resources and projected fine grain resource utilization for applications based on past application fine grained resource usage characteristics; a means for generating per-framework resource guidance filter information by comparing the current utilization of fine grained resources for the coarse grained resources to the projected fine grain resource utilization for the applications, and maintaining a database of allocable coarse grain resources; and a means for employing the per-framework resource guidance filter information to generate resource guidance filters for application to the allocable coarse grain resources to guide resource requests to the central cluster resource management layer, and for receiving coarse grained resources from the node local resource management layer in response to the resource requests to the central cluster resource management layer.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A computer-implemented method for resource management comprising:
monitoring current utilization of fine grained resources for corresponding coarse grained resources;
determining application usage characteristics of the fine grained resources over time;
projecting expected fine grain resource utilization for the application based on the application usage characteristics;
generating node local guidance information for at least one framework of a plurality of frameworks requesting the coarse grained resources, the node local guidance generated by comparing the current utilization of fine grained resources to the expected fine grain resource utilization for the application; and
communicating the node local guidance information to a resource manager for allocation of the coarse grained resources.

2. The computer implemented method of claim 1, wherein comparing the current utilization of fine grained resources to the expected fine grain resource utilization for the application includes detecting prospective saturation in fine grained resource utilization when the coarse grained resources are allocated to the application.

3. The computer implemented method of claim 1, wherein the fine grained resources include at least one of processor pipeline utilization, processor pipeline occupancy, cache bandwidth, cache hit rate, cache pollution, memory bandwidth, non-uniform memory access latency, and coherence traffic.

4. The computer implemented method of claim 1, wherein fine grained resources include any resource that describe an operational status of any of the coarse grain resources.

5. The computer implemented method of claim 4, wherein the coarse grained resources includes at least one of a number of compute cores, a random-access memory (RAM) space, a storage capacity, and disk quota.

6. The computer implemented method of claim 1, monitoring current utilization of fine grained resources includes monitoring hardware counters configured to count fine grain resource utilization for the coarse grained resources.

7. The computer implemented method of claim 1, wherein the resource manager is a Central Cluster Resource Manager (CCRM), and the node local guidance information is communicated to the CCRM to support generation of per-framework resource guidance filters based on the node local guidance information to guide resource requests.

8. A computer implemented method of resource management comprising:
receiving node local guidance information including expected fine grain resource utilization for a plurality of applications, current fine grain resource utilization, for corresponding coarse grained resources, and coarse grained resource allocations;
maintaining a resource availability database based on the coarse grained resource allocations;
generating resource guidance filter information for a plurality of frameworks associated with the applications by comparing the current fine grain resource utilization for the coarse grained resources to expected fine grain resource utilization for the applications; and
providing the resource guidance filter information and information from the resource availability database to the frameworks to support generating resource guidance filters to mask coarse grain resources when current fine grain resource utilization for the coarse grained resources plus expected fine grain resource utilization for an application exceeds a threshold.

9. The computer implemented method of claim 8, wherein the fine grained resource utilization includes at least one of a processor pipeline utilization, a cache bandwidth, a cache hit rate, a memory bandwidth, and a non-uniform memory access latency.

10. The computer implemented method of claim 8, wherein the coarse grained resources include at least one of a number of compute cores, a random-access memory (RAM) space, a storage capacity, and disk quota.

11. The computer implemented method of claim 8, wherein the resource guidance filters are applied to information from the resource availability database to provide a per-framework view of available coarse grained resources across a plurality of computing nodes in a network.

12. The computer implemented method of claim 11, wherein the resource requests utilize a lazy update whereby the resource availability database is only updated when a request for resources is received from a framework.

13. The computer implemented method of claim 11, wherein the resource guidance filters are determined by the frameworks and are employed to mask resource availability database information to remove resource nodes from consideration when determining resource requests.

14. The computer implemented method of claim 11, wherein fine grained resources include any resource that describe an operational status of any of the coarse grain resources.

15. A system for resource management, comprising:
a Node Local Resource Managers (NLRM) configured to generate node local guidance information based on current utilization of fine grained resources for corresponding coarse grained resources and projected fine grain resource utilization for applications based on past application fine grained resource usage characteristics;
a Central Cluster Resource Manager (CCRM) configured to generate per-framework resource guidance filter information by comparing the current utilization of fine grained resources for the coarse grained resources to the projected fine grain resource utilization for the applications, and maintain a database of allocable coarse grain resources; and
an application layer in communication with the central cluster resource management layer, wherein the application layer includes a plurality of frameworks operating on one or more processors, the frameworks configured to employ the per-framework resource guidance filter information to generate resource guidance filters for application to the allocable coarse grain resources to guide resource requests to the central cluster resource management layer, and receive coarse grained resources from the node local resource management layer in response to the resource requests to the central cluster resource management layer.

16. The system of claim 15, wherein the node local guidance information is further based on a utilization of fine grained resources including at least one of a processor pipeline utilization, a cache bandwidth, a cache hit rate, a memory bandwidth, and a non-uniform memory access latency as measured by hardware performance counters managed by the NLRM.

17. The system of claim 15, wherein the coarse grained information includes at least one of a number of compute cores, a random-access memory (RAM) space, a storage capacity, and disk quota.

18. The system of claim 15, wherein the central cluster resource management layer utilizes a lazy update whereby a resource availability database is only updated when a request for resources is received from the application layer.

19. The system of claim 15, wherein comparing the current utilization of fine grained resources for the coarse grained resources to the projected fine grain resource utilization for the applications includes detecting prospective saturation in fine grained resource utilization when the coarse grained resources are allocated to the applications.

20. The system of claim 15, wherein the resource guidance filters are employed to mask resource availability database information from the central cluster resource management layer to remove resource nodes from consideration when determining resource requests.
